(19) United States
(12) Patent Application Publication
(10) Pub. No.: US 2025/0078493 A1
(43) Pub. Date: Mar. 6, 2025

(54) DOMAIN GENERALIZATION METHOD, SERVER AND CLIENT

(71) Applicant: Lenovo (Beijing) Limited, Beijing (CN)

(72) Inventors: Yuxuan LIU, Beijing (CN); Yahong ZHANG, Beijing (CN); Chenchen FAN, Beijing (CN)

(21) Appl. No.: 18/821,251

(22) Filed: Aug. 30, 2024

(30) Foreign Application Priority Data
Sep. 1, 2023 (CN) 202311126219.1

(51) Int. Cl. G06V 10/94; G06V 10/764; G06V 10/82

(52) U.S. Cl. CPC G06V 10/95; G06V 10/764; G06V 10/82

(57) ABSTRACT

The present disclosure provides a domain generalization method, device, server, and client. The method includes acquiring image discrimination information uploaded from multiple clients, wherein the image discrimination information is obtained by discriminators in the clients, the discriminators evaluating enhanced image generated by a generator in the server based on initial image of the respective clients, the initial image including amplitude information; and updating the generator based on the image discrimination information to obtain an updated generator; sending a multi-domain mixed image generated by the updated generator to the clients; and determining domain generalization parameters for classifiers in each client, based on model update parameters obtained after the clients update their classifiers using the initial image and the multi-domain mixed image.

### CROSS-REFERENCE TO RELATED APPLICATION

This application claims priority to Chinese Patent Application No. 202311126219.1, filed on Sep. 1, 2023, and the entire content of which is incorporated herein by reference.

### TECHNICAL FIELD

The present disclosure relates to the field of computer technology, specifically to a domain generalization method, a server, and a client.

### BACKGROUND

In deep learning, often a model performs well on the training set, but performs significantly worse on the test set, which makes the model unable to achieve good results in unknown target domains. To improve the model performance with domain generalization, related technologies often rely on learning invariant features across multiple domains. However, this approach brings the risk of data leakage. Therefore, how to improve the generalization ability of a global model in a target domain while protecting source domain data privacy in a federated learning scenario is a problem that needs to be addressed.

### SUMMARY

One aspect of the present disclosure provides a domain generalization method. The method is applied to a server. The method includes acquiring image discrimination information uploaded from multiple clients, wherein the image discrimination information is obtained by discriminators in the clients, the discriminators evaluating enhanced image generated by a generator in the server based on initial image of the respective clients, the initial image including amplitude information; and updating the generator based on the image discrimination information to obtain an updated generator; sending a multi-domain mixed image generated by the updated generator to the clients; and determining domain generalization parameters for classifiers in each client, based on model update parameters obtained after the clients update their classifiers using the initial image and the multi-domain mixed image.

Another aspect of the present disclosure provides a domain generalization method. The method is applied to a client. The method includes acquiring the initial image and the multi-domain mixed image; the initial image includes amplitude information and phase information; and processing the multi-domain mixed image and the initial image to achieve multi-domain image; and updating the parameters of the classifiers in the client based on the multi-domain image and the initial image to achieve the model update parameters, and sending the model update parameters to the server; and acquiring domain generalization parameters determined by the server based on the model update parameters; and updating the classifier parameters based on the domain generalization parameters to achieve a domain generalization model.

The sixth aspect of the present disclosure provides a domain generalization server, including executable instructions stored on a computer-readable storage medium; when the server or client reads and executes the executable instructions from the computer-readable storage medium, they perform the domain generalization method in the present disclosure.

It shall be understandable that the above general description and the following detailed description are merely exemplary and explanatory, and should not limit the present disclosure.

### BRIEF DESCRIPTION OF THE DRAWINGS

To clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a schematic diagram of an embodiment of the domain generalization method in the present disclosure.

FIG. 2 is a flowchart of an exemplary method for determining target category information according to an embodiment of the present disclosure;

FIG. 3 is a block diagram of a classification device as the embodiment of the present disclosure;

FIG. 4 is a block diagram of an electronic device, as the embodiment of the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

In the following description, “some embodiments” describe a subset of all possible embodiments. However, it is understandable that “some embodiments” may refer to the same subset or different subsets of all possible embodiments and can be combined without conflict.

In the following description, the terms “first,” “second,” and “third” are used only to distinguish similar objects and do not represent a specific order of the objects. It is understood that “first,” “second,” and “third” may be interchangeable in terms of specific sequence or order where applicable, allowing the embodiments of the present disclosure to be implemented in an order different from what is illustrated or described herein.

Unless otherwise defined, all technical and scientific terms used herein have the same meaning as commonly understood by those skilled in the art to which this disclosure pertains. The terminology used herein is for the purpose of describing the embodiments of the present disclosure and is not intended to limit the present disclosure.

Currently, the out-of-distribution (OOD) generalization problem exists in various fields such as healthcare, industry, and finance. Federated learning, a concept introduced in recent years, is a distributed machine learning technique. Essentially, it uses multiple user devices collaboratively to train a global model, that represents all the user devices. Federated learning is a new privacy-preserving paradigm primarily designed to handle the data from different domains. This approach is modeled on the assumption that user data in the training set across different devices is not independently and identically distributed (non-IID). However, in federated learning with non-IID data, the problem of decreased accuracy on the test dataset, particularly the OOD generalization problem, still remains unresolved.

In federated learning method, domain generalization means the process of learning a model from multiple source domains, so that the model is able to generalize to an unknown target domain. Most domain generalization methods require centralized collection of data from different domains. However, due to privacy concerns, distributed collection is commonly adopted. Despite this, distributed collection is still not able to fully ensure data privacy in federated learning process.

In related technologies, solving the OOD domain generalization problem typically involves leveraging multiple domains to learn invariant features across different domains. However, a unique characteristic of federated learning is that data remains localized. Consequently, the federated OOD problem has three specific scenarios. The first scenario is about learning a federated model from multiple distributed source domains, in order to train a global model which can generalize to a new domain for a new user. The second scenario is about training a global generalized model that can benefit multiple local models, enhancing their generalization performance, while ensuring that the test accuracy does not fall below the training accuracy. The third scenario is about training a global domain generalization model that can handle the issue of non-independent and identically distributed (non-IID) data, while the practical data is non-IID.

To address the above issues, Fourier transform is employed to decompose local image data into amplitude data (low-level semantic information) and phase spectrum data (high-level semantic information). In this case, the amplitude information is shared as common data with other source domains, while the phase information is preserved locally without exchanging with other source domains. Then, the local amplitude spectrum is randomly linearly interpolated with the shared amplitude spectrum from other source domains. Then, the achieved interpolated amplitude spectrum is combined with the locally preserved phase spectrum through inverse Fourier transform, to reconstruct the image. At this point, the image preserves phase information, and contains distribution information from multiple source domains, thereby enabling domain generalization by learning domain-invariant features from multiple domains. However, the method in related technologies has a risk of privacy leakage. Although the above low-level semantic information does not contain the phase information of the image, it could still include pixel distribution information. Furthermore, this approach does not address the issue of non-IID data in federated learning.

To address the issues in related technologies, the present disclosure provides a domain generalization method. This method trains a generator using distributed training of a generative adversarial network (GAN). Note that while using GAN, in the training process, the input to the generator can be just Gaussian noise. This avoids accessing the local data of users in multiple domains. The generator output data then shall be validated by the discriminator of each domain to determine the authenticity of the generated data, in order to optimize the generator. Afterword, the multi-domain mixed image, which is determined by the discriminators as authentic, are broadcasted to users, and then processed with the data from multiple domains, to obtain the multi-domain data containing information from various domains. As a result, the domain generalization parameters of the model can be obtained, based on the above multi-domain data. In this way, the generation of multi-domain mixed image does not relay on accessing the local data of each source domain, thereby avoiding the risk of privacy data leakage. Therefore, under the condition of protecting the privacy of source domain data, this domain generalization model is able to achieve good generalization performance in the target domain.

In some embodiments of the present disclosure, the training process of the generator shall include the following steps. Firstly, while fixing the parameters of the generator, apply the training on the discriminator, improving its discrimination performance between real data and the generated data from the generator. Then, while fixing the parameters of the discriminator, apply the training on the generator, so that the generated data is able to ‘fool’ the discriminator as effectively as possible. Iteratively and alternatively, process the above two steps until the model converges. In the phase of training the generator, the generator shall first produce some ‘false’ data, and then feed into the discriminator for evaluation. The goal of the generator is to make the discriminator believe that these ‘false’ data are ‘real.’ To achieve this, a loss function is defined to measure the extent of the discriminator's error. In this case, gradient descent algorithm is used to update the to the generator's parameters and minimize the loss function, resulting in a well-trained generator ultimately.

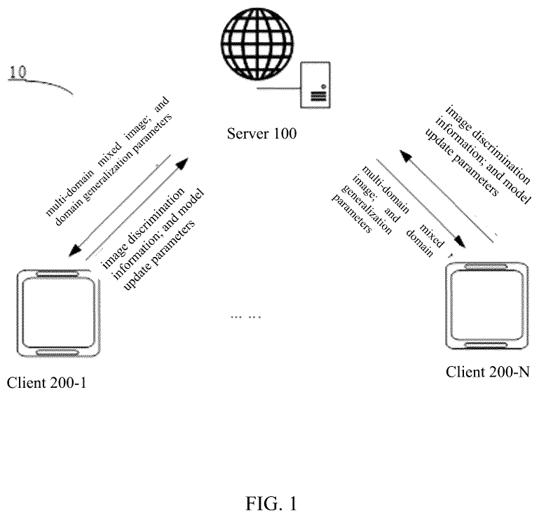

FIG. 1 is a schematic diagram of an embodiment of the domain generalization method in the present disclosure. The present disclosure provides a domain generalization system 10, which includes a server 100 and multiple clients, such as clients 200-1 to 200-N. Each client is responsible for storing the data corresponding to its respective source domain, training the local model using the source domain data, and exchanging model parameters with the server. Moreover, the server 100 contains a generator. The server is responsible for functions include: training the generator, aggregating and distributing model parameters from the various clients, and aggregating a global domain generalization model. The resulting global domain generalization model can then be applied to data from an unknown target domain. The interaction between the clients and the server 100 can be achieved through a network, which may be a wide area network (WAN), a local area network (LAN), or a combination of both.

As shown in FIG. 1, in this embodiment of the present disclosure, during model domain generalization, the server 100 acquires the image discrimination information from multiple clients. Then, the server updates the generator based on the image discrimination information, to achieve an updated generator. The updated generator then generates multi-domain mixed image, and then sends it to each client. The server determines domain generalization parameters for the classifiers in each client, based on model update parameters achieved after the clients update their classifiers using the initial image and the multi-domain mixed image. Each client acquires the initial image and the multi-domain mixed image, and then processes the data to achieve multi-domain image. Then each client updates the classifier parameters, based on the multi-domain image and the initial image, meanwhile, generates the model update parameters. Then the clients send these model update parameters to the server, and receive the domain generalization parameters from the server. Based on these domain generalization parameters, the client updates its classifier, so that resulting in a domain generalization model that is suitable be applied to an unknown target domain.

The following content is an exemplary application of the domain generalization method in the present disclosure, running on a server. The technical solutions in the embodiments of this disclosure will be clearly and comprehensively described in conjunction with the figures/drawings.

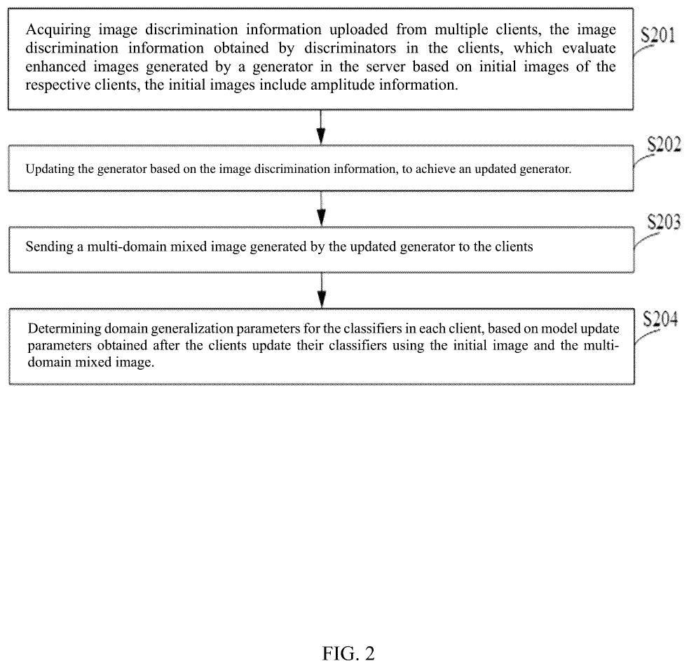

FIG. 2 is a flowchart of an embodiment of the domain generalization method, applied on a server. As shown in FIG. 2, the method includes steps from S201 to S204.

At S201: The server acquires image discrimination information uploaded from multiple clients. The image discrimination information is from the discriminator in each client, which discriminates the enhanced image generated by the generator in the server based on the initial image in each client. In this case, the initial image includes amplitude information.

Here, different clients belong to different source domains, and responsible for storing the data of the corresponding source domains (such as the initial image), training the local model on the source domain (such as a local classifier), and interacting with the server, to exchange the parameters of the local model.

In this embodiment of the present disclosure, to prevent data leakage, the generator in the server does not access the local data of each source domain, when generating enhanced image. In this case, the generator can output an enhanced image just based on random Gaussian noise, in the process of the generating enhanced image in the server. The authenticity of the generated enhanced image is then determined by the discriminator in each client. If the image is determined as false, then the image discrimination information is generated and sent back to the server.

In some embodiments of the present disclosure, the initial image is the local image data in each client. Domain generalization is to learn the invariant features existed in multiple domains, which is also call the generalizable features. For example, the features can be the contours of cat or dog. This initial image contains amplitude information and phase information, where the amplitude information represents low-level semantic information, including generalizable features such as contours, while the phase information contains non-generalizable features specific to each source domain, such as the image style of each source domain, such as a cartoon style or realistic style. Therefore, when the discriminators in each client evaluate the enhanced image generated by the generator, they do so by assessing the amplitude information of the initial image.

In some embodiments of the present disclosure, when the discriminators in each client evaluate the enhanced image, the image discrimination information, i.e., the loss of the discriminator, is calculated using the following formula (1):

$${max}_{D} {L}_{Di} = - log ( {D}_{i} ( {X}_{i} ) ) - log ( 1 - {D}_{i} ( G ( z ) ) ) , \qquad ( 1 )$$

wherein Dᵢ is the client, with i=1 . . . N; Xᵢ indicates the initial image of each client; G represents the generator, and z is the random Gaussian noise. Here, the discriminator's loss is the criterion of the discriminator's error. The server then uses gradient descent algorithm to update the parameters of the generator, minimizing the generator's loss function. This process aims to make the image generated by the generator closely match the data distribution of all source domains.

In some embodiments of the present disclosure, when it is difficult for the discriminator to distinguish between the local initial image and the enhanced image generated by the generator, it means that the features contained in the enhanced image are invariant features across multiple source domains, also known as the domain generalization features. This indicates that the features learned by the generator are general, and can be generalized to unknown domains.

At S202, the generator is updated, based on the image discrimination information, to obtain an updated generator.

In some embodiments of the present disclosure, when the local discriminator in each client determines that the enhanced image is false, the client uploads the image discrimination information to the server. The server then trains the generator based on the image discrimination information, and updates the generator. The updated generator is used to generate a new enhanced image, which is again evaluated by the client's local discriminator to determine its authenticity. If the newly generated enhanced image is still false, the server continues to train the generator based on the new image discrimination information. This process shall be repeated until the discriminator determines that the image generated by the generator is real. In this case, the server achieved the updated generator.

In some embodiments of the present disclosure, the generator's loss function can be derived based on the loss from each discriminator in the clients, and the generator can be updated accordingly based on the generator's loss. The generator's loss min_{G} L_{G} is calculated using the following formula (2):

$${min}_{G} {L}_{G} = log ( 1 - Agg ( {D}_{i} ( G ( z ) ) ) ) ; \qquad ( 2 )$$

wherein Agg indicates the aggregator, which is used to aggregate the discriminator losses from the clients.

In the process of updating the generator, only the local discriminator D in each client is able to access its initial image. This effectively prevents privacy leakage. This approach achieves federated domain generalization of the local model, leveraging the information from multiple source domains, without actually accessing data from other source domains.

At S204, the server sends the multi-domain mixed image generated by the updated generator to the clients.

In some embodiments of the present disclosure, when the local discriminator of each client determines that the enhanced image is real, the server determines that the enhanced image is the multi-domain mixed image, and then broadcasts it to each client.

In this case, the updated generator directly generates the multi-domain mixed image containing multi-domain distribution information based on random Gaussian noise, thereby preventing data leakage from the source domains.

At S204, the server determines the domain generalization parameters of classifier in each client, based on the model update parameters, achieved after the clients update their classifiers using the initial image and the multi-domain mixed image.

In some embodiments of the present disclosure, after receiving the multi-domain mixed image sent by the server, each client updates its classifier parameters using its initial image and the multi-domain mixed image, to obtain the updated model update parameters. These model update parameters are then uploaded to the server. The server processes the model update parameters from all the clients, to obtain the domain generalization parameters for each client's classifier. The domain generalization parameters here are the model parameters that have learned invariant features across multiple source domains. The client's classifier is suitable to use for new source domain, after learning such domain generalization features, from multiple domains.

In some embodiments of the present disclosure, the server processes the model update parameters uploaded by each client by averaging the parameters, or by assigning weights to each client based on their data volume. The model update parameters are then weighted according to the assigned weights, resulting in the final domain generalization parameters. Additionally, the server can use distributed optimization algorithms based on federated learning, such as the FedAvg algorithm, to aggregate the model update parameters from all clients, deriving the domain generalization parameters.

In some embodiments of the present disclosure, first, the server generates enhanced image and sends them to each client. The clients then use their local initial image to evaluate the received enhanced image, generating image discrimination information. The server then trains the generator based on this image discrimination information, resulting in an updated generator. This approach ensures that the generator update process does not use the local data from the client, thus preventing any privacy data leakage from the source domains. As a result, the generator can produce multi-domain mixed image that possess domain generalization features from multiple source domains, while still protecting the privacy of the data in source domain. Next, the updated generator generates multi-domain mixed image containing information from multiple domains, and then sends these images to the clients. Each client then updates its classifier parameters using the initial image and the multi-domain mixed image, resulting in model update parameters. The domain generalization parameters are then determined based on these model update parameters. The classifiers in each client, using these domain generalization parameters, shall have good generalization capabilities in the target or new domains.

In some embodiments of the present disclosure, different clients may have different volumes of data. In order to address the problem of non-independent and identically distributed (non-IID) data, caused by varying volumes of local data across different clients. The present disclosure provides a method for determining the model weight for each client based on the number of samples in each client, and use the weights to solve the non-IID data problem across clients. Based on the embodiment of the present disclosure, the domain generalization further includes the following steps S1 and S2:

At S1, the embodiment determines the number of samples of the initial images corresponding to each client.

In some embodiments of the present disclosure, different clients may have different numbers of samples of initial image, which causes different contributions to the domain generalization parameters. To avoid the non-independent and identically distributed (non-IID) problem caused by sample size imbalance, this embodiment obtains the sample sizes from different clients and then applies weighting adjustments to the model update parameters of each client.

At S2, the embodiment determines model weights of each client based on the number of samples from each client and the total number of samples from all clients.

In some embodiments, after obtaining the sample size of each client, the inverse proportion of the sample size can be used as the model weight for each client. This means that clients with fewer samples have larger weights, while clients with more samples have smaller weights. The approach ensures that each sample contributes equally to the domain generalization model.

For example, if there are N clients, and each client has nᵢ samples, then the weight of each client can be calculated by (3):

$${w}_{i} = N / ( {n}_{i} * {\sum }_{j = 1}^{N} {n}_{j} ) \qquad ( 3 )$$

wherein Σⱼ₌₁^{N} nⱼ is the summation of the number among all clients' samples.

Accordingly, S204 can be obtained by sub-steps S2041 and S2042 as follows:

At S2041: the embodiment acquires the model update parameters of each client, after the clients update their classifiers using the initial image and the multi-domain mixed image.

In some embodiments, after receiving the multi-domain mixed image sent by the server, each client updates the parameters of its classifier based on its initial image and the multi-domain mixed image, generating updated model update parameters. These updated parameters are then uploaded to the server by each client.

At S2042: a weighted calculation is performed on the model update parameters from each client, based on the model weights of each client, to achieve the domain generalization parameters.

In this embodiment of the present disclosure, the model update parameters from each client are weighted according to the respective client's model weight. This approach ensures that the contribution of different clients to the global generalization model is as balanced as possible, thereby preventing the degradation of model generalization performance caused by imbalance data contributions. As a result, the model that used the domain generalization parameters, is able to obtain good performance in new domains.

In some embodiments of the present disclosure, to generate multi-domain mixed image that contains domain-invariant features from multiple clients, the image generated by the generator needs to be evaluated by the local discriminators of each client. If the image does not pass the evaluation, the generator shall be updated based on the discrimination information, and then the new image shall be generated by the updated generator. This process is repeated with the local discriminators of the clients until the generated multi-domain mixed image are discriminated as real by the local discriminators. Moreover, the domain generalization method provided by this embodiment further includes the following steps:

At S3, acquiring random Gaussian noise.

At S4, generating initial enhanced images based on the generator and the random Gaussian noise, and then sending these initial enhanced images to each client.

In some embodiments of the present disclosure, before the updating the generator, its input is random Gaussian noise, and its output is the initial enhanced image. This initial enhanced image is then sent to each client, so that the clients then perform discrimination using the initial enhanced image.

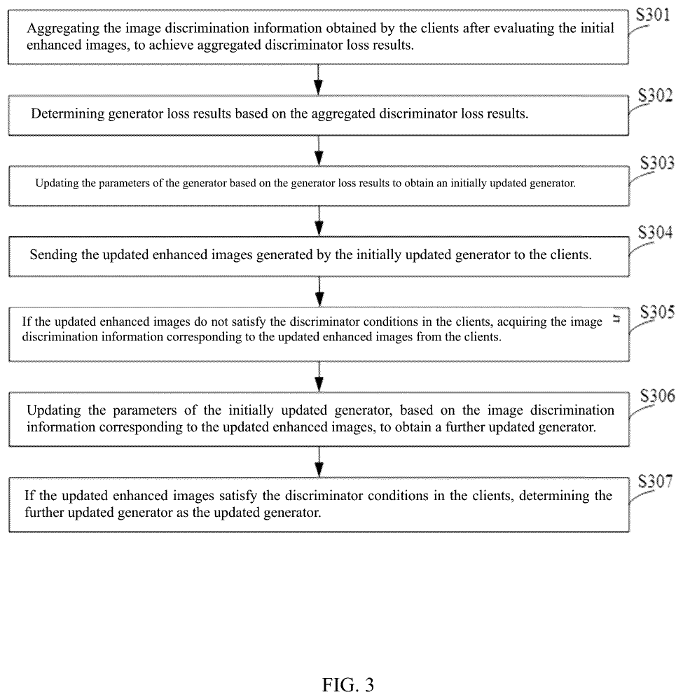

In some embodiments of the present disclosure, as shown in FIG. 3, the process of updating the generator, which is S102, can be achieved by sub-steps from 301 to S307:

At 301: aggregating the image discrimination information obtained by the clients after evaluating the initial enhanced images, to achieve an aggregated discriminator loss result.

In some embodiments of the present disclosure, the image discrimination information obtained by clients after evaluating the initial enhanced image, is determined by the loss of each client's discriminator. The discriminator's loss is calculated using formula (4).

$${max}_{D} {L}_{Di} = - log ( {D}_{i} ( {X}_{i} ) ) - log ( 1 - {D}_{i} ( G ( z ) ) ) \qquad ( 4 )$$

wherein Dᵢ is the client, with i=1 . . . N; Xᵢ indicates the initial image of each client; G represents the generator, and z is the random Gaussian noise. Here, the discriminator's loss is the criterion of the discriminator's error. The server then uses gradient descent algorithm to update the parameters of the generator, minimizing the generator's loss function.

In some embodiments of the present disclosure, Agg indicates the aggregator, which is used to aggregate the discriminator losses from the clients. This step calculates the result from aggregated discriminator loss, which is denoted as Agg(D₁(G(z))).

At S302: determining the generator loss result, based on the aggregated discriminator loss results.

Further the generator loss result can be calculated by formula (5), based on the aggregated discriminator loss:

$${min}_{G} {L}_{G} = log ( 1 - Agg ( {D}_{i} ( G ( z ) ) ) ) ; \qquad ( 5 )$$

At S303, updating the parameters of the generator based on the generator loss result, to achieve an initially updated generator. Here, the initially updated generator refers to the generator after it has undergone one update.

At S304, sending the updated enhanced image generated by the initially updated generator to each client.

In some embodiments of the present disclosure, the initially updated generator generates the updated enhanced image based on random Gaussian noise for another time, and then sends the enhanced image to each client.

At S305, if the updated enhanced image does not satisfy the discrimination criteria of the discriminators in each client, the server shall obtain the image discrimination information corresponding to the updated enhanced image uploaded by each client.

Here, the discrimination criteria of the discriminator are whether the discriminator discriminates the updated enhanced image as real. If the discriminators in the clients discriminate the updated enhanced image as false, then it indicates that the updated enhanced image does not satisfy the discriminator criteria. Here, image discrimination information shall be generated for another time based on the loss of discriminator and then uploaded to the server.

At S306: updating the parameters of the initially updated generator based on the received image discrimination information corresponding to the updated enhanced image, to achieve a further updated generator.

The above further updated generator then generates a new enhanced image based on random Gaussian noise, and the discriminators in each client shall evaluate the new enhanced image again. This iterative process shall continue, until the generator is able to produce enhanced image that satisfies the discrimination criteria of the discriminators in each client, which means until the discriminators evaluate the enhanced image as real.

At S307, if the updated enhanced images satisfy the discriminator conditions in the clients, determining the further updated generator as the updated generator.

In some embodiments of the present disclosure, when the enhanced image generated by the generator satisfy the discrimination criteria of the discriminators in each client, these image, which have been evaluated as real, are considered the multi-domain mixed image containing multi-domain information. The generator that produced these images is then confirmed as the updated generator.

This embodiment iteratively updates the generator through the interaction between the discriminators and the generator, so that the generator is able to produce multi-domain mixed image that contain domain-invariant features without accessing data of each source domain. This approach allows the generator to learn multi-domain information while preventing data leakage from each source domain.

Next, the following explanation is about the exemplary application of the domain generalization method when implemented on the client side. The embodiment of the present disclosure will be illustrated with a clear and comprehensive description of the technical solutions, with reference to the figures.

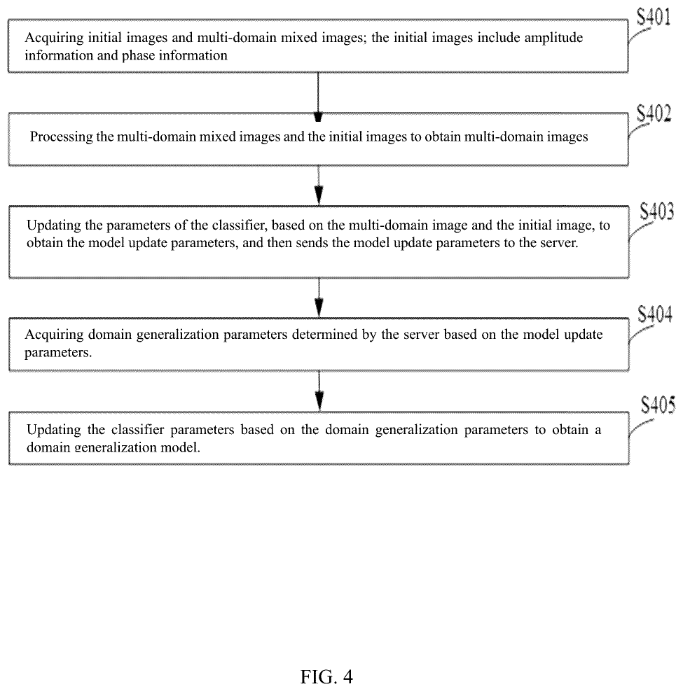

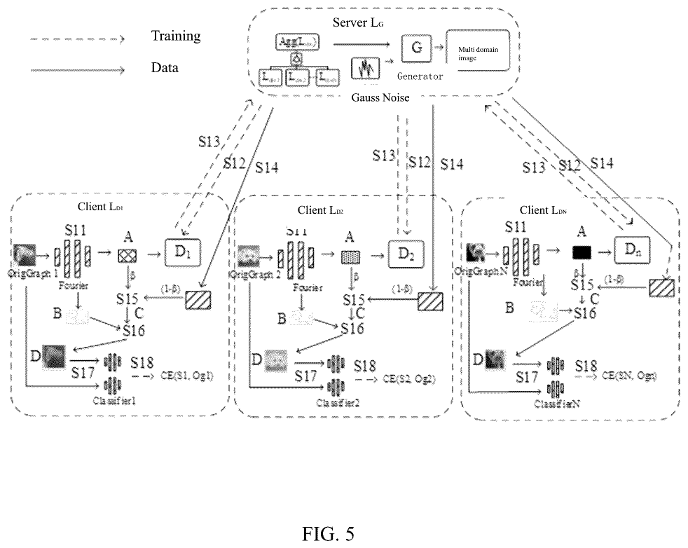

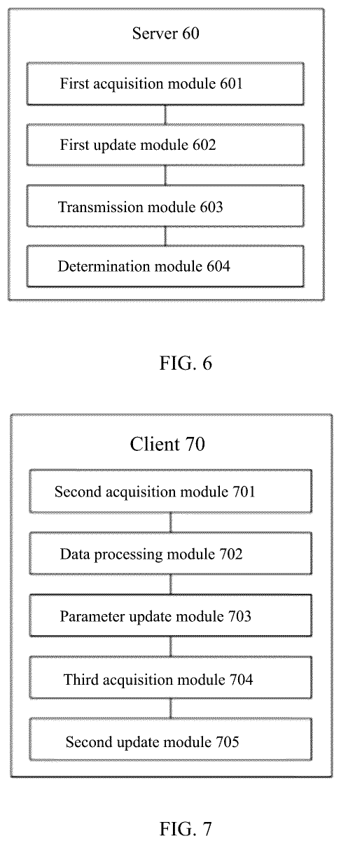

FIG. 4 is a flowchart of the domain generalization method running the client, in this embodiment of the present disclosure. As shown in FIG. 4, the method includes sub-steps from S401 to S405:

At S401, acquiring the initial image and the multi-domain mixed image. The initial image includes amplitude information and phase information.

In some embodiments of the present disclosure, the initial image includes amplitude information and phase information. The amplitude information represents low-level semantic features, including generalizable features such as contours, while the phase information includes non-generalizable features specific to each source domain, such as the image style (e.g., cartoon style or realistic style).

At S402, processing the multi-domain mixed image and the initial image to obtain a multi-domain image.

In some embodiments of the present disclosure, the local client discriminates the enhanced image generated by the generator based on the amplitude information of the initial image. Therefore, the multi-domain mixed image contains amplitude information from multiple domains. By processing the multi-domain mixed image with the initial image, the multi-domain image can be obtained. It includes both the amplitude information from multiple domains and the local phase information. Therefore, this multi-domain image contains generalization features from multiple domains and also non-generalizable, personalized features from the local client.

In some embodiments of the present disclosure, S402 further includes sub-steps S4021 and S4022.

At S4021, the client performs interpolation calculations on the amplitude information obtained by Fourier decomposition of the initial image and the multi-domain mixed image, to achieve interpolated image.

In some embodiments of the present disclosure, the client performs Fourier decomposition on the initial image is the approach to achieve the amplitude and phase information from image. The amplitude information and the multi-domain mixed image are then linearly interpolated to generate the interpolated image.

The linear interpolation can be calculated using formula (6)

$${X}_{i} = β {x}_{i} + ( 1 - β ) {g}_{i} \qquad ( 6 )$$

wherein, β indicates the proportion of amplitude information in the initial image, Xᵢ indicates the interpolated image of the i-th client, xᵢ indicates the amplitude information of the initial image, and gᵢ indicates the multi-domain mixed image.

At S4022, this client performs an inverse Fourier transform on the interpolated image, and the phase information obtained from the Fourier decomposition of the initial image, in order to obtain the multi-domain image.

After acquiring the interpolated image, this client performs inverse Fourier transform on the interpolated image, and the phase information of the initial image, to achieve multi-domain image that includes both the amplitude information from multiple domains and the local phase information.

At S403, updating the parameters of the classifier, based on the multi-domain image and the initial image, to achieve the model update parameters, and then sends the model update parameters to the server.

In some embodiment of the present disclosure, after obtaining the multi-domain image and the initial image, both images can be input into the classifier in the client. And this results in two classification outcomes. By comparing these two classification outcomes, the loss result can be obtained, using a cross-entropy loss function. Based on this loss result, the parameters of the classifier in the client are updated to generate the model update parameters, which are then sent to the server.

At S404, acquiring domain generalization parameters is determined by the server based on the model update parameters.

At S405, updating the classifier parameters based on the domain generalization parameters to achieve a domain generalization model.

In this case, after acquiring the domain generalization parameters generated by the server, the parameters of the classifier shall be updated based on these parameters, in order to obtain a domain generalization model. This model not only learns the invariant features from the various source domains, but also learns the non-generalizable local features.

In some embodiment of the present disclosure, each client trains the server-end generator through its discriminator, and updates the local classifier using the multi-domain mixed image generated by the generator. The server aggregates the model update parameters from each client to generate the domain generalization parameters. The local classifier is then updated based on these domain generalization parameters to create a domain generalization model, which learned multi-domain features. This approach enables the training process of a domain generalization model with strong generalization capabilities in the target or new domain, while preventing the leakage of local data.

In some embodiments of the present disclosure, the embodiment updates the parameters of the classifier in the client, so that to obtain the model update parameters. This process includes sub-steps S10 and S30:

At S10, based on the classifier in the client, then embodiment obtains a first classification result and a second classification result, through classification processing on the multi-domain image and the initial image separately.

In some embodiments of the present disclosure, the multi-domain image and the initial image are input into the same classifier respectively, to obtain the first classification result and the second classification result.

The method applied to the client also includes the process that obtaining the model weights determined by the server based on the number of samples of the initial image from each client. In that case, S10 further includes: performing classification processing on the multi-domain image and the initial image respectively, based on the classifier and the model weight, then outputting the first classification result and the second classification result. In this case both classification results are carrying the model weight.

In this embodiment, in order to address the problem of non-independent and identically distributed data, caused by imbalanced local data volumes of different clients, a model weight can be applied after the softmax output layer in the local classifier. In this case, clients with fewer samples shall multiply by a larger model weight, while clients with more samples shall multiply by a smaller model weight. This approach ensures that the contribution capacity of different clients to the global domain generalization model is as close as possible, avoiding the problem of generalization performance degradation due to the imbalanced data contributions.

Therefore, the output layer of the local classifier can be multiplied by the model weight corresponding to that client, to achieve the first classification result and the second classification result, both carrying the model weights.

At S20: the client determines the classifier loss result based on the first classification result, the second classification result, and the classifier loss function.

In some embodiments of the present disclosure, the classifier loss function can be a cross-entropy loss function, which calculates the similarity between the first classification result and the second classification result. This similarity is then used to determine the loss result of the classifier.

At S30: the client updates the parameters of the classifier based on the loss result to obtain the model update parameters.

In this case, the local classifier is optimized based on the loss result. This optimization procedure allows the local classifier to learn the domain-invariant features across multiple clients.

In some embodiments of the present disclosure, personalization on the local model can be achieved, by adding a model weight matrix after the classifier output layer, mitigating the impact of non-independent and identically distributed data, and ensuring that the contribution capacity of different clients to the global domain generalization model is as close as possible. This approach helps to address the problem of generalization performance degradation caused by imbalanced data contributions.

The present disclosure further provides aa application of the domain generalization method.

To address the problems in related technologies, this embodiment offers a domain generalization method. This method provides efficient client privacy protection. In the first phase, a generator is trained on the server using adversarial neural networks through distributed training. The generator's input can be Gaussian noise in the training, and the output is an image containing multi-domain features. The generated image contains information from multiple domains (i.e., clients). Because the information from multiple domains is mixed, it is not possible to be identified, which eliminates the risk of privacy leakage. Since the generator does not need to access the users' local data, the generated image consists of unidentifiable mixed information. In the meanwhile, the generated image is evaluated by the local discriminator in the user's client, which is then used to optimize the generator. The generated mixed image (i.e., multi-domain mixed image) are then broadcast to each user's client and linearly combined with the initial amplitude information. This combined data is then processed by inverse Fourier transform, with the phase information, resulting in an enhanced image containing multi-domain information (i.e., multi-domain image). Thereby, this method solves the problem of training a global model using different users' local data in a privacy-preserving federated learning context.

In the second phase, a weight matrix is added after the output layer of the local model in the client's side. This is used to address the problem of non-independent and identically distributed data problems caused by imbalanced data contributions.

In some embodiments of the present disclosure, the generator on the server reconstructs multi-domain information through distributed federated learning. The training of the generator only requires guidance from the discriminator loss function and the generator loss function. Since there is no need to access the source data from clients, privacy leakage issues can be prevented effectively.

In some embodiments of the present disclosure, in the training process of the generator, the generator loss function on the server end is as formula (7):

$${min}_{G} {L}_{G} = log ( 1 - Agg ( {D}_{i} ( G ( z ) ) ) ) ; \qquad ( 7 )$$

wherein Agg indicates the aggregator, which is used to aggregate the discriminator losses; G represents the generator, and z is the random Gaussian noise; and D indicates the discriminator.

In some embodiments of the present disclosure, the loss function of each client's discriminator is as formula (8):

$${max}_{D} {L}_{Di} = - log ( {D}_{i} ( {X}_{i} ) ) - log ( 1 - {D}_{i} ( G ( z ) ) ) \qquad ( 8 )$$

wherein X indicates the initial image information.

During the training process of the generator, only the client's local discriminator (D) is capable to access the local raw data. The generator on the server end does not need to access the client end local data. It only uses the discrimination information provided by the discriminator, to generate mixed amplitude image, where the image contains multi-domain distribution information. This approach effectively prevents the issue of privacy leakage, and allows the local model to remain isolated from other data, while still leveraging information from multiple source domains for federated domain generalization.

In this disclosure, to address the imbalance issue caused by non-independent and identically distributed (non-IID) data, a customized weight layer (also means the model weighting) is added to the local classifier (i.e., the client end classifier). For domains (i.e., clients) which have fewer samples, they are multiplied to larger weights, while domains with more sample, they are multiplied to smaller weights. This ensures that the contribution of different domains to the global generalization model is balanced, so that to prevent the issue of the model's generalization performance degradation caused by imbalance data contributions. In this case, the sample size of each domain can be calculated, and then the model weight can be the inverse of the sample size. In this way, domains with fewer samples have larger weights, while domains with more samples have smaller weights. This makes each sample contribute roughly equally to the model.

By setting a weight matrix (i.e., model weighting) at the output layer of the local classifier, the local model (i.e., client classifier) is then personalized, mitigating the impact of non-IID data.

FIG. 5 is a diagram of the federated domain generalization method provided in this embodiment of the present disclosure. As shown in FIG. 5, the federated domain generalization method includes a server L_{G}, and multiple clients, which are from L_{D1} to L_{DN}. The dashed lines indicate the training process of the generator within the server, and the solid lines indicate the data flow.

As shown in FIG. 5, the federated domain generalization method includes sub-steps from S11 to S14:

At S11, each client performs a Fourier transform on the original image termed OrigGraph (i.e., the initial image), decomposing it into amplitude information A and phase information B.

At S12, the generator G on the server generates an enhanced image based on random Gaussian noise, and the local discriminators in the clients (D₁ to D_{N} as shown in FIG. 4) evaluate the authenticity of this enhanced image.

At 513, if the local discriminator at a client determines that the enhanced image is false, then the image discrimination information is uploaded to the server. The server aggregates the received image discrimination information from all clients (i.e., the loss functions L_{dis1} to L_{disN} of the discriminators) to determine the loss function Agg(L_{dis}) of the generator. The generator G is then trained based on its loss function, and its parameters are updated. The updated generator the produces a new enhanced image, which is again evaluated by the local discriminators in the clients. If the image is still false, the server has to continue the training of the generator using the new image discrimination information. The training process is needed to repeat until the discriminator evaluates the generated image as true.

At S14, if the local discriminator at a client evaluates that the enhanced image is real, then this image is determined as a multi-domain mixed image, which shall be then broadcasted to every client.

At 515, the multi-domain mixed image is interpolated with the local amplitude information A of each client to obtain the interpolated image C.

In some embodiments of the present disclosure, the interpolation can be calculated using formula (9):

$${X}_{i} = β {x}_{i} + ( 1 - β ) {g}_{i} \qquad ( 9 )$$

wherein, β indicates the proportion of amplitude information A in the initial image, Xᵢ indicates the interpolated image of the i-th client, xᵢ indicates the amplitude information of the initial image, and gᵢ indicates the multi-domain mixed image.

At S16, inverse Fourier transform is applied on the interpolated image and the local phase information B to generate the multi-domain image D.

At S17, the original image OrigGraph and the multi-domain image D are input into two identical classifiers on the local client to obtain two classification results.

Here, due to the differences in local data among different users, a weight matrix is applied to the output layer of the local classifier. Users with less data are assigned higher weights, while users with more data are assigned lower weights.

At S18, optimization is applied on the output results of the two classifiers using the cross-entropy loss function. This optimization makes the local classifier able to learn domain-invariant features. They use the FedAvg algorithm to aggregate the local model parameters from multiple users, and broadcast the aggregated parameters to each local classifier for model parameter updating, resulting in the domain generalization model CE.

In some embodiments of the present disclosure, a distributed generative adversarial neural network is used to generate undistinguishable amplitude image containing multi-domain information. This procedure effectively mitigates the risk of privacy leakage, and provides a new paradigm for solving the federated OOD (Out-of-Distribution) problem. Additionally, by setting a weight matrix at the output layer of the classifier to personalize the local model, it prevents the influence from non-independent and identically distributed data.

The present application further provides a server. FIG. 6 is a diagram of the server provided in the present disclosure. As shown in FIG. 6, the server 60 includes a first acquisition module 601, a first update module 602, a transmission module 603, and a determination module 604.

First acquisition module 601, is configured to acquire the image discrimination information uploaded by multiple clients. This image discrimination information is obtained by the discriminator in each client, after evaluating the enhanced image generated by the generator in the server and the initial image in the client. The initial image includes amplitude information. First update module 602 is configured to update the generator based on the image discrimination information, resulting in an updated generator. Transmission module 603, is configured to send the multi-domain mixed image generated by the updated generator to each client. Determination module 604, is configured to determine the domain generalization parameters of the classifier in each client, based on the model update parameters generated after classifier in each client is updated using the initial image and the multi-domain mixed image.

In some embodiments of the present disclosure, the server further includes: a first determination module, which is configured to determine the number of samples of the initial images corresponding to each client; a second determination module, which is configured to determine the model weight of each client, based on the number of samples from each client and the total number of samples of all clients. Correspondingly, the determination module 604 can be further used to obtain the model update parameters after the classifier in each client is updated using the initial image and the multi-domain mixed image, and then to perform weighted calculation on the model update parameters based on the model weight of each client, to achieve the domain generalization parameters.

In some embodiments of the present disclosure, the server further includes: a fourth acquisition module, which is configured to acquire random Gaussian noise; a generation module, which is configured to generate the initial enhanced image based on the generator and the random Gaussian noise, and then send the initial enhanced image to each client.

In some embodiments of the present disclosure, the first update module 602 is further used to aggregate the image discrimination information obtained from each client, when they evaluate the initial enhanced image, to achieve an aggregated discriminator loss result. Then generator loss results can be determined based on the aggregated discriminator loss result, and the parameters of the generator are updated accordingly to obtain an initially updated generator. The updated enhanced image generated by the initially updated generator is then sent to each client. If the updated enhanced image does not satisfy the discrimination conditions of the discriminators in the clients, the image discrimination information corresponding to the updated enhanced image uploaded by the clients is acquired. The generator is then updated again based on this image discrimination information to obtain a further updated generator. When the updated enhanced image satisfies the discrimination conditions of the discriminators in the clients, the further updated generator is determined as the updated generator.

The present disclosure further provides a client. FIG. 7 is a diagram of the client. As shown in FIG. 7, the client 70 includes a second acquisition module 701, a data processing module 702, a parameter update module 703, a third acquisition module 704, and a second update module 705.

Second acquisition module 701 is used to acquire the initial image and the multi-domain mixed image. The initial image includes amplitude information and phase information. Data processing module 702 is used to process the multi-domain mixed image and the initial image to obtain the multi-domain image. Parameter update module 703 is used to update the parameters of the classifier in the client based on the multi-domain image and the initial image, resulting in model update parameters, and send these model update parameters to the server. Third acquisition module 70, is used to acquire the domain generalization parameters determined by the server based on the model update parameters. Second update module 705, is used to update the classifier's parameters based on the domain generalization parameters, resulting in a domain generalization model.

In some embodiments of the present disclosure, the data processing module 702 is further used to perform interpolation calculation. It obtains obtain an interpolated image, between the amplitude information obtained from the Fourier decomposition of the initial image, and the multi-domain mixed image. Then, the module process inverse Fourier transform on the interpolated image and the phase information obtained from the Fourier decomposition of the initial image, to obtain the multi-domain image.

In some embodiments of the present disclosure, the parameter update module 703 is further used to perform classification on the multi-domain image and the initial image using the classifier in the client. The classification obtains the first classification result and the second classification result. Then, the classifier loss result is determined based on the first and second classification results, and the loss function. The classifier parameters are then updated based on the loss result, in order to obtain the model update parameters.

In some embodiments of the present disclosure, the client further includes: a fifth acquisition module, which is used to acquire the model weight. The weight is determined by the server based on the number of samples of the initial image for each client. Correspondingly, the parameter update module 703 is further used to perform classification on the multi-domain image and the initial image based on the classifier and the model weight, respectively, and output the first classification result and the second classification result, which are carrying the model weight.

The description of the embodiments of the present disclosure provided above is similar to the description of the method embodiments and shares similar beneficial effects. For technical details not disclosed in some embodiments of the present disclosure, please refer to the description of the method embodiments provided.

It should be noted that in some embodiments of the present disclosure, if the domain generalization method is implemented in the form of software functional modules and is sold or used as an independent product, it can also be stored in a computer-readable storage medium. Based on this understanding, the technical solutions of the embodiments of the present disclosure, or the contributions made to the relevant technology, can be embodied in the form of a software product, which is stored in a storage medium and includes some instructions that enable an electronic device (such as a personal computer, server, or network device) to execute entire or part of the methods described in the embodiments of the present disclosure. The aforementioned storage medium includes USB flash drives, mobile hard disks, read-only memory (ROM), magnetic disks, optical disks, or any other media that can store program codes. In this way, the embodiments of the present disclosure are not limited to any specific hardware and software combination.

The embodiment of the present disclosure provides an electronic device. The device shall include a memory and a processor. The memory stores a computer program that, when executed by the processor, implements the domain generalization method described above.

The embodiment of the present disclosure also provides a computer-readable storage medium on which a computer program is stored. When the program is executed by a processor, the computer shall also execute the domain generalization method described above. The computer-readable storage medium can be either transient or non-transient.

The embodiment of the present disclosure also provides a computer program product. This product includes a non-transient computer-readable storage medium storing a computer program. When the computer program is read and executed by a computer, the computer shall execute some or all of the steps of the above method. The computer program product can be implemented in different forms including hardware, software, or a combination thereof. In one embodiment, the computer program product can be a computer storage medium. In another embodiment, the computer program product can be a software product, such as a software development kit (SDK).

It should be understood that the term “an embodiment” or “some embodiments” throughout the specification means that a particular feature, structure, or characteristic included in at least one embodiment of the present application. Therefore, the appearance of the phrase “in an embodiment” or “in one embodiment” in various places throughout the specification does not necessarily refer to the same embodiment. Furthermore, the specific features, structures, or characteristics may be combined in any suitable manner in one or more embodiments. It also should be understood that, in various embodiments of the present disclosure, the order of the steps described above does not imply that the steps must be performed in that specific sequence. The execution order of the steps should be determined by their function and internal logic, and should not impose any limitation on the implementation process of the embodiments of this application. The numbering of the embodiments above is only for the purpose of description and does not indicate the superiority or inferiority of the embodiments.

It should be noted that, the terms “include”, “comprise” or any other variant thereof are intended to cover non-exclusive inclusion, so that a process, method, article or device including a series of elements includes not only those elements, but also other elements not explicitly listed, or also includes elements inherent to such a process, method, article or device. In the absence of further restrictions, the elements defined by the sentence “including one . . . ” do not exclude the existence of other identical elements in the process, method, article or device including the elements.

In some embodiments in the present disclosure, it should be understood that the disclosed devices and methods can be implemented in various ways. The device embodiments described above are merely illustrative; for example, the division of units is only a logical division of functions. In actual implementation, there may be other division methods, such as combining multiple units or components, integrating them into another system, or omitting some features or not performing them. Additionally, the coupling, direct coupling, or communication connections between the components shown or discussed can be through some interface, device, or unit's indirect coupling or communication connection, and may be electrical, mechanical, or other forms.

The units described as separate components may be or may not be physically separated, and the components shown as units may be or may not be physical units; they may be located in one place or distributed across multiple network units. Parts or all of the units may be selected to implement the purpose of the embodiments of the present disclosure as required.

Additionally, in some embodiments of the present disclosure, the functional units may all be integrated into one processing unit, or each unit may be separately used as a unit, or two or more units may be integrated into one unit. The integrated units may be implemented in hardware or in a combination of hardware and software functional units.

Those skilled in the art can understand that all or part of the steps of the described method can be accomplished by program instructions related to hardware. The program can be stored in a computer-readable storage medium, and when executed, the program performs the steps of the method. The storage medium includes mobile storage devices, ROM, magnetic disks, optical disks, and other media that can store program codes.

Alternatively, if the integrated unit described above is implemented in the form of a software functional module, and is sold or used as an independent product, it can also be stored in a computer-readable storage medium. Based on this understanding, the technical solution of this application, or the part that contributes to the related technology, can be a software product, which is stored in a storage medium, including some instructions that allow an electronic device (which may be a personal computer, server, or network device, etc.) to execute all or part of the methods of the present disclosure. The storage medium includes mobile storage devices, ROM, magnetic disks, optical disks, and other possible media that can store program codes.

The above description is merely some embodiments of the present disclosure. It should be pointed out that for ordinary technicians in this technical field, various improvements and modifications can be made without departing from the principles of the present disclosure. These improvements and modifications should also be regarded as the scope of protection of the present disclosure.

What is claimed is:

1. A domain generalization method, applied to a server, the method comprising:
acquiring image discrimination information uploaded from multiple clients, wherein the image discrimination information is obtained by discriminators in the clients, the discriminators evaluating an enhanced image generated by a generator in the server based on an initial image of the respective clients, the initial image including amplitude information; and
updating the generator based on the image discrimination information to obtain an updated generator; and
sending a multi-domain mixed image generated by the updated generator to the clients; and
determining domain generalization parameters for classifiers in each client based on model update parameters obtained after the clients update their classifiers using the initial image and the multi-domain mixed image.

2. The method according to claim 1, further comprising:
determining a number of samples of initial images corresponding to each client; and
determining model weights of each client based on the number of samples from each client and a total number of samples from all clients; and
determining the domain generalization parameters for the classifiers in each client, based on the model update parameters obtained after the clients update their classifiers using the initial image and the multi-domain mixed image, comprising:
acquiring the model update parameters of each client after the client updates its classifiers using the initial image and the multi-domain mixed image; and
performing weighted calculation on the model update parameters of each client based on the model weights of each client, to obtain the domain generalization parameters.

3. The method according to claim 1, further comprising:
acquiring random Gaussian noise; and
generating initial enhanced image based on the generator and the random Gaussian noise, and sending the initial enhanced image to the clients.

4. The method according to claim 3, wherein updating the generator based on the image discrimination information, to obtain the updated generator, includes:
aggregating the image discrimination information obtained by the clients after evaluating the initial enhanced image, to obtain an aggregated discriminator loss result; and
determining a generator loss result based on the aggregated discriminator loss result; and
updating parameters of the generator based on the generator loss result to obtain an initially updated generator; and
sending updated enhanced image generated by the initially updated generator to the clients; and
if the updated enhanced image does not satisfy discriminator conditions in the clients, acquiring the image discrimination information corresponding to the updated enhanced image from the clients; and
updating the parameters of the initially updated generator, based on the image discrimination information corresponding to the updated enhanced image, to obtain a further updated generator; and
if the updated enhanced image satisfies the discriminator conditions in the clients, determining the further updated generator as the updated generator.

5. A domain generalization method, applied to a client, the method comprising:
acquiring an initial image and a multi-domain mixed image, the initial image includes amplitude information and phase information; and
processing the multi-domain mixed image and the initial image to obtain a multi-domain image; and
updating parameters of classifiers in the client based on the multi-domain image and the initial image to obtain the model update parameters, and sending the model update parameters to a server; and
acquiring domain generalization parameters determined by the server based on the model update parameters; and
updating the classifier parameters based on the domain generalization parameters to obtain a domain generalization model.

6. The method according to claim 5, wherein processing the multi-domain mixed image and the initial image to obtain the multi-domain image includes:
performing interpolation calculation on the amplitude information obtained by Fourier decomposition of the initial image and the multi-domain mixed image to obtain an interpolated image; and
performing inverse Fourier transform on the interpolated image and the phase information obtained by Fourier decomposition of the initial image to obtain the multi-domain image.

7. The method according to claim 5, wherein updating the classifier parameters in the client based on the multi-domain image and the initial image to obtain model update parameters, includes:
classifying the multi-domain image and the initial image separately using the classifiers in the client to obtain a first classification result and a second classification result; and
determining a classifier loss result based on the first classification result, the second classification result, and a classifier loss function; and
updating the classifier parameters based on the loss result to obtain the model update parameters.

8. The method according to claim 7, further comprising:
acquiring model weights determined by the server, based on a number of samples of the initial images from each client; and
classifying the multi-domain image and the initial image separately using the classifiers in the client to obtain the first classification result and the second classification result, comprising:
classifying the multi-domain image and the initial image separately using the classifiers and the model weights, and outputting the first classification result and the second classification result, the first and second classification results carrying the model weights.

9. A domain generalization server including one or more processors and a computer readable storage medium storing one or more computer program instructions, when executed by the one of more processors, the computer program instructions implementing a domain generalization method comprising:
acquiring image discrimination information uploaded from multiple clients, wherein the image discrimination information is obtained by discriminators in the clients, the discriminators evaluating an enhanced image generated by a generator in the server based on an initial image of the respective clients, the initial image including amplitude information; and
updating the generator based on the image discrimination information to obtain an updated generator; and
sending a multi-domain mixed image generated by the updated generator to the clients; and
determining domain generalization parameters for classifiers in each client based on model update parameters obtained after the clients update their classifiers using the initial image and the multi-domain mixed image.

10. The server according to claim 9, the domain generalization method further comprising:
determining a number of samples of initial images corresponding to each client; and
determining model weights of each client based on the number of samples from each client and a total number of samples from all clients; and
determining the domain generalization parameters for the classifiers in each client, based on the model update parameters obtained after the clients update their classifiers using the initial image and the multi-domain mixed image, comprising:
acquiring the model update parameters of each client after the client updates its classifiers using the initial image and the multi-domain mixed image; and
performing weighted calculation on the model update parameters of each client based on the model weights of each client, to obtain the domain generalization parameters.

11. The server according to claim 9, the domain generalization method further comprising:
acquiring random Gaussian noise; and
generating initial enhanced image based on the generator and the random Gaussian noise, and sending the initial enhanced image to the clients.

12. The server according to claim 11, wherein updating the generator based on the image discrimination information, to obtain the updated generator, includes:
aggregating the image discrimination information obtained by the clients after evaluating the initial enhanced image, to obtain an aggregated discriminator loss result; and
determining a generator loss result based on the aggregated discriminator loss result; and
updating parameters of the generator based on the generator loss result to obtain an initially updated generator; and
sending updated enhanced image generated by the initially updated generator to the clients; and
if the updated enhanced image does not satisfy discriminator conditions in the clients, acquiring the image discrimination information corresponding to the updated enhanced image from the clients; and
updating the parameters of the initially updated generator, based on the image discrimination information corresponding to the updated enhanced image, to obtain a further updated generator; and
if the updated enhanced image satisfies the discriminator conditions in the clients, determining the further updated generator as the updated generator.
